(19) United States
(12) Patent Application Publication
(10) Pub. No.: US 2022/0355513 A1
(43) Pub. Date: Nov. 10, 2022

(54) Charges for Mold Maintenance

(71) Applicant: Arris Composites Inc., Berkeley, CA (US)

(72) Inventors: Bert D. MANNHALTER, El Cerrito, CA (US); Andrew T. BRADY, El Cerrito, CA (US); Allison R. LIGHT, Orinda, CA (US)

(21) Appl. No.: 17/736,751

(22) Filed: May 4, 2022

Related U.S. Application Data
(60) Provisional application No. 63/184,597, filed on May 5, 2021.

(51) Int. Cl. B29C 33/72

(52) U.S. Cl. CPC B29C 33/72; B33Y 80/00

(57) ABSTRACT

A method for cleaning or treating a mold includes form a cleaning charge or a release-agent charge, placing the charge in a mold cavity and applying heat and pressure to the charge, thereby conforming the charge to the mold cavity and forming a mock part, and then ejecting and discarding the mock part. During processing of the cleaning charge, contaminants adhering to the walls of the mold cavity from previous molding runs are incorporated into the mock part. During processing of the release-agent charge, release agent is transferred from the charge to the surface of the mold cavity.

### STATEMENT OF RELATED CASES

This specification claims priority of U.S. Pat. App. 63/184,597, filed May 5, 2021 and which is incorporated by reference herein.

### FIELD OF THE INVENTION

The present invention relates to the molding processes.

### BACKGROUND

Molding involves shaping a malleable or otherwise liquefied constituent material into a desired form. Molding processes, of which there are many, typically require a mold cavity that receives one or more constituent molding materials, which usually include a polymer. The mold cavity defines the final shape of molded article. During molding, the molding constituents may be subject to heat, elevated pressure, and/or vacuum, as a function of the molding process. In a final processing step, the material(s) in the mold cool and harden, attaining the final form. The finished article is then removed from the mold.

There are certain ancillary considerations pertaining to molding. One such consideration is facilitating release of the finished article from the mold, and a second is cleaning the mold.

With respect to release, the polymer used as a molding constituent may contain additives that promote release of the finished article from the mold, so-called “internal release agents.” Over time, these release agents coat the surface of the mold, effectively providing a continuous application of release agent. These release agents work well for neat polymers, but can be detrimental for composites (i.e., polymer plus reinforcement, such as fiber). In particular, such additives often weaken the interface between the polymer and fiber, which negatively impacts the mechanical properties of a fiber-reinforced composite article.

Consequently, in most composite molding processes, an external release agent—a release agent applied directly to the mold surface—is used to promote release of the finished part from the mold. These agents are usually in liquid or aerosol form.

As to the second consideration—mold cleaning—it is common to clean molds between molding runs or when changing polymer constituents. Mold cleaning is typically performed manually, usually via burn-out and/or scraping.

For fiber-composite molding, the application of release agents and conducting mold cleaning interrupts the production cycle, thereby increasing processing costs of the article being molded. As such, processes for the fabrication of composite parts would benefit from improvements in the application of mold-release agents and manner in which molds are cleaned.

### SUMMARY

The present invention provides a way to clean molds and/or apply release compound in an automated/automatable manner, and which is applicable to molding processes for the fabrication of fiber-composite parts, as well as neat-polymer based parts.

In accordance with the present teachings, filaments of purge compound and filaments of release additive are formed, if not otherwise available. For cleaning, an assemblage of the purge-compound filaments is formed. To treat the mold cavity with the release agent, an assemblage of the release-agent filaments is formed.

The filaments of the assemblages are 3D-printed, or tacked together under appropriate temperature and pressure, forming either a “cleaning charge” or a “release charge.” In the illustrative embodiment, these charges—each in the form of a unitary body—will have a shape and dimensions that are consistent with that of the relevant mold cavity.

It is notable that the cleaning charge and release charge are analogous to applicant's “preform charge,” which is an assemblage of fiber-bundle-based preforms. The preform charge, which was invented by applicant, serves as an expedient for organizing composite (i.e., polymer and fiber) molding constituents within a mold in conjunction with applicant's molding processes. This approach provides an unprecedented ability to align fibers within a finished part with the anticipated in-use stress vectors, among other benefits. See, e.g., US 2020/0114596 A1 and US 2020/0361122 A1, incorporated by reference herein.

After being placed in a mold cavity, the cleaning charge or release charge is “molded” to form a “mock part” via methods, such as compression molding, similar to those used by applicant. But whereas such methods are normally used to fabricate a fiber-composite part meeting certain application-specific mechanical specifications, in embodiments of the invention, they are not. Rather, the resulting mock part, which is discarded (or otherwise not placed in service), is simply the result of the processing that is used to clean or treat the mold in accordance with embodiments of the invention. More particularly, with respect to the cleaning charge, any material/flash/contaminants adhering to the surface of the mold from prior molding runs is incorporated into the mock part, which is then ejected from the mold cavity. With respect to the release charge, the mock part, once ejected from the mold, leaves a coat of release agent on the mold surface. Consequently, after ejection from the mold, the mock part is discarded.

A molding run with a release charge and a molding run with a cleaning charge is typically performed, respectively, with the same frequency as release agent has historically been applied to a mold and with the same frequency as molds have been cleaned. As those skilled in the art will appreciate, this will vary with molding process, processing conditions, and molding constituents, among any other factors.

In comparison with the conventional approach to cleaning/treating, there is less downtime associated with embodiments of the invention, due to compatibility with existing process architecture (e.g., can be handled by existing automation and process robots, etc.). The impact on the production cycle of fiber-composite parts is simply one less finished part per cleaning cycle, and one less finished part per release-treatment cycle. But as a consequence of the far less disruptive approach to cleaning and treating molds, the reduction in downtime more than compensates for one less finished part per cleaning/treatment cycle. Moreover, the use of the release charge enables the use of internal release agents, but does not compromise the mechanical properties of high-performance fiber-composite parts since it is applied via a separate “charge” that does not produce a usable part.

Some embodiments in accordance with the present teachings provide a method comprising:

providing a charge, the charge including purge compound or mold-release agent, wherein a volume of the charge is sufficient to fill the mold cavity, the charge having a near-net-shape;

placing the charge in the mold cavity;

molding the charge, forming a mock part, by applying heat and pressure; and

ejecting and discarding the mock part.

Some embodiments in accordance with the present teachings provide a method comprising:

providing a filament comprising purge compound or mold-release agent;

forming a charge from the filament, wherein a volume of the charge is sufficient to fill the mold cavity, the charge having a near-net-shape;

placing the charge in the mold cavity;

applying heat and pressure to the charge, thereby conforming the charge to the mold cavity and forming a mock part; and

ejecting and discarding the mock part.

Some embodiments in accordance with the present teachings provide a cleaning charge for cleaning a mold cavity, the cleaning charge comprising purge compound, and wherein a volume of the cleaning charge is sufficient to fill the mold cavity, the charge having a near-net-shape form.

Some embodiments in accordance with the present teachings provide a release charge for treating a mold cavity, the release charge comprising a release agent and base polymer, wherein a volume of the release charge is sufficient to fill the mold cavity, the charge having a near-net-shape form.

### BRIEF DESCRIPTION OF THE DRAWINGS

FIG. 1 depicts a method in accordance with the illustrative embodiment of the invention.

FIG. 2 depicts a first embodiment of a cleaning charge or a release charge for use in conjunction with the method of FIG. 1.

FIG. 3 depicts a second embodiment of a cleaning charge or a release charge for use in conjunction with the method of FIG. 1.

### DETAILED DESCRIPTION

The cleaning charge for use in conjunction with embodiments of the invention can be a commercially available purge compound, such as those produced and sold by Dyna-Purge company (www.dynapurge.com). Such compounds are typically mixtures of a base polymer, such as polypropylene or polycarbonate, with other additives, including perfumes. Alternatively, and without limitation, neat, generic polypropylene or polycarbonate can be used as the cleaning charge.

Release agents (internal) suitable for use in conjunction with embodiments of the invention include, without limitation, metal soaps (e.g., zinc stearate, calcium stearate, sodium stearate, magnesium stearate, etc.), silicone polymers, and fluoropolymers.

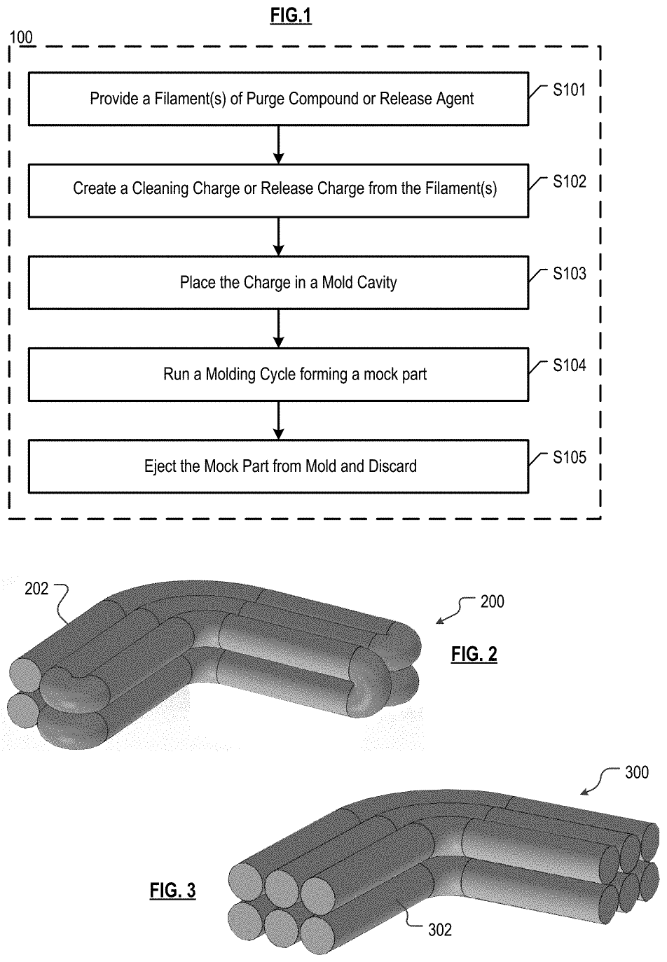

FIG. 1 depicts, via flow chart, method 100 in accordance with illustrative embodiment, including, in the illustrative embodiment, tasks S101 through S105.

In task S101, a filament of purge compound or release agent is obtained. The filament of purge compound is typically 100% commercially available purge compound, or 100% generic polymer, such as polypropylene or polycarbonate. The filament of release agent can contain release agent in the amount of 0.025% to 80% by weight, the balance being a carrier polymer, such as, without limitation, polypropylene or polycarbonate.

The filament of purge compound or release agent can be produced via an extrusion process. In the case of the release agent, in some embodiments, a carrier polymer and release agent are compounded together using a screw-type extruder, and the mixture is extruded (through a die) as a filament and collected on a spool. The purge compound is likewise extruded through a die to create a filament. The filament can have any convenient diameter (or cross-sectional dimensions), but will typically be about 1 millimeter in diameter.

In task S102, a cleaning charge or a release charge is formed. In some embodiments, the charges are formed via a 3D printer, wherein the filament containing purge compound or release agent is fed to the 3D printer. The printer then prints the charge in a near net shape. As used in this disclosure and the appended claims, the phrase “near-net shape” or “near-net-shape form,” when referencing the shape/form/dimensions of the cleaning charge or release charge, means that the charge has a shape/size very similar to that of the mock part to be formed. The significance of this being that the charge will therefore be well fit to the shape/size of the mold cavity being cleaned/treated. In this regard, the overall volume of the charge will be slightly in excess of the overall volume of the closed mold cavity, the excess allowing for charge material lost to “flash” during processing. In some embodiments, the charge is sized to be slightly smaller (10-20 percent) than the mold cavity in terms of its width and length, but somewhat deeper (i.e., thicker). As the mold cavity is closed, the charge is therefore compacted (i.e., squished). As the charge is exposed to elevated temperature and pressure, it melts and is pressurized, and therefore flows through the mold. Such movement, which is facilitated by the somewhat undersized charge, aids in the cleaning or treatment process.

FIG. 2 depicts cleaning charge or a release charge 200 formed via a 3D printer in accordance with the present teachings. Typically, but not necessarily, a single long filament of material for the cleaning charge or the release charge is fed to the 3D printer. Charge 200 is depicted as being printed in a single, continuous deposition of filament 202. It will be appreciated that in some other embodiments, depending on the specifics of the 3D printer, the charge can be printed as a series of depositions of material. In either case, the resulting charge is a unitary mass.

Alternative methods for organizing the filaments into a cleaning charge or a release charge may suitably be used. For example, in some embodiments, multiple filaments are placed in a fixture that is arranged to create an assemblage of such filaments, wherein the assemblage has a near-net shape. In some embodiments, the charge-forming fixture comprises an arrangement of cleats against which the filaments are stacked. In some other embodiments, the charge-forming fixture includes a cavity, wherein the cavity has dimensions similar to that of the mold cavity to be treated. The filaments are stacked within the cavity.

After the filaments are arranged in the charge-forming fixture, they are tacked together via the application of heat and minimal pressure. For “tacking,” the filaments are not fully melted, but rather softened, such that they substantially maintain their shape. The temperature a filament softens will vary with the materials used, and such softening temperature can be readily determined by those skilled in the art. As previously noted, the pressure applied to the filaments is relatively minimal, typically less than 100 psig, and more typically less than 50 psig. One or more clamps can be used to apply pressure to the assemblage of filaments. In some cases, gravity alone provides sufficient downward force for tacking.

FIG. 3 depicts cleaning charge or release charge 300 formed using a charge-forming fixture having a cavity or cleats, in accordance with the present teachings. In the depicted embodiment, plural cleaning filaments or release filaments 302 are organized into an assemblage. For pedagogical purposes, the charge is depicted as being composed of six discrete filaments 302; in an actual charge formed from a charge-forming fixture, the discrete nature of the filaments is lost to a large extent.

In some embodiments, the cleaning charge and/or the release charge includes fibers. The presence of the fibers can be beneficial, particularly in the case of the cleaning charge; they facilitate removal of residue/material from the surface of the mold. Moreover, in embodiments in which a charge-forming fixture is used, the presence of fibers reduce the severity of deformation that may occur to the filaments to the extent they must be bent to conform to the cavity or arrangement of cleats of the charge-forming fixture.

Fibers suitable for use in conjunction with embodiments of the invention include any fibers conventionally used for molding. Since, however, the mock part will be discarded, there is a preference for using relatively less-expensive fibers. Such fibers will typically be in the form of milled fiber or chopped fiber. The fibers are typically resin-impregnated, and in some embodiments, the process is operated at a temperature that is sufficient to melt such resin. Still other ways for forming the release and cleaning charges, as will occur to those skilled in the art in light of the present disclosure, may suitably be used.

It is notable that although the polymers (either the “base” polymer or any polymer associated with fibers) used in accordance with embodiments of the invention will be melted during processing, the various chemicals used for cleaning and treating are not melted, but rather dispersed in the melted polymers.

In task S103, the purge charge or release-agent charge is place in the mold cavity, and then the mold is closed. In task S104, a (mock) molding cycle is run, producing a mock part. As used in this disclosure and the appended claims, the phrase “mock part” refers to the end result of subjecting the purge charge or release-agent charge to a (mock) molding cycle according with the present teachings. The mock part is not designed to achieve any particular mechanical specifications, nor is it used after the process is complete. In fact, the mock part is discarded or otherwise set aside after it is ejected from the mold. The temperature of the mock molding cycle is a function of the melting temperature of the polymers used in conjunction with the purge agent or the release agent. In some embodiments, the pressure at which the process is conducted is less than is used during conventional compression molding to form a fiber-composite part, since there is no concern about the mechanical properties of the mock part. Yet, it is important that the charge is distributed fully throughout the mold cavity during processing. Consequently, it is likely that the mock part is fully consolidated.

In task S105, the mock part is ejected and discarded or set aside. In the case of the cleaning charge, the mock molding process will cause the mock part to absorb/collect any contamination that is present in the mold cavity, which will therefore be removed as the part is ejected. In the case of the release charge, the molding process will result in the transfer of the release agent from the charge to the surface of the mold cavity.

It is to be understood that the disclosure describes a few embodiments and that many variations of the invention can easily be devised by those skilled in the art after reading this disclosure and that the scope of the present invention is to be determined by the following claims.

What is claimed:

1. A method for maintaining a mold cavity, the method comprising:
providing a charge, the charge including purge compound or mold-release agent, wherein a volume of the charge is sufficient to fill the mold cavity, the charge having a near-net shape;
placing the charge in the mold cavity;
molding the charge, forming a mock part, by applying heat and pressure; and
ejecting and discarding the mock part.

2. The method of claim 1 wherein providing the charge comprises forming the charge from a filament comprising purge compound or mold-release agent.

3. The method of claim 2 comprising extruding the filament.

4. The method of claim 2 wherein providing the charge comprises 3D-printing the charge.

5. The method of claim 1 wherein the charge comprises fiber.

6. The method of claim 2 wherein the filament comprises fiber.

7. The method of claim 6 wherein providing the charge comprises stacking a plurality of filaments in a charge fixture and the tacking the plurality of filaments together, wherein all of the filaments of the plurality include the purge compound, or all of the filaments of the plurality include the mold-release agent.

8. A method for maintaining a mold cavity, the method comprising:
providing a filament comprising purge compound or mold-release agent;
forming a charge from the filament, wherein a volume of the charge is sufficient to fill the mold cavity, the charge having a near-net shape;
placing the charge in the mold cavity;
applying heat and pressure to the charge, thereby conforming the charge to the mold cavity and forming a mock part; and
ejecting and discarding the mock part.

9. The method of claim 8 wherein forming the charge comprises printing the charge via a 3D printer.

10. A cleaning charge for cleaning a mold cavity, the cleaning charge comprising purge compound, and wherein a volume of the cleaning charge is sufficient to fill the mold cavity, the charge having a near-net shape.

11. The cleaning charge of claim 10 wherein the cleaning charge comprises at least one filament, wherein the at least one filament includes the purge compound.

12. A release charge for treating a mold cavity, the release charge comprising a release agent and base polymer, wherein a volume of the release charge is sufficient to fill the mold cavity, the charge having a near-net shape.

13. The release charge of claim 12 wherein the release charge comprises at least one filament, wherein the at least one filament includes the release agent and the base polymer.
